(19) United States
(12) Patent Application Publication
(10) Pub. No.: US 2016/0037752 A1
(43) Pub. Date: Feb. 11, 2016

(54) Elephant Vexing

(71) Applicant: Mary Anne Paglieri, Redwood City, CA (US)

(72) Inventor: Mary Anne Paglieri, Redwood City, CA (US)

(21) Appl. No.: 14/455,872

(22) Filed: Aug. 8, 2014

(51) Int. Cl. A01K 15/04; A01K 29/00; E04H 17/00; A01K 3/00

(52) U.S. Cl. CPC A01K 15/04; A01K 3/00; A01K 29/00; E04H 17/00

(57) ABSTRACT

A method to stop persistent fence-breaking behavior of crop-raiding ‘Habitual Raider’ (HRs) elephants constructs fences that are fitted with bells every 10 ft-20 ft around crop fields needing protection, and affixes bells to pre-existing fences. The HRs are conditioned by punishment that causes pain but not injury immediately after they sound the bells in an attempt to break through the fences. Afterwards the bells become a signal for the HRs that punishment is coming, eventually causing the HRs to be deterred by the sound of the bells alone, without having to use bear-scare darts or rubber bullets again.

### BACKGROUND OF THE INVENTION

One of the two greatest threats to elephant survivability besides ivory poaching is the lesser-known practice of retaliatory killing and lethal management of elephants that raid crops. There is mounting evidence that rural areas of high human poverty experience higher levels of ivory poaching (IUCN 2013). This suggests greater incentive to illegally kill elephants where livelihood and food insecurity is caused by raiding and destruction of crops, and poaching may be seen as an opportunity to supplement income (Maingi 2012). There is a direct relationship between the wellbeing of people and elephants in areas where they coexist.

Attempts to mitigate human-elephant conflicts have also resulted in the closure of critically important migration corridors that could have detrimental consequences to both the ecosystem and the survivability of elephant populations. Elephants are a ‘keystone herbivore’ (Owen-Smith 1989), and their impact on vegetation is beneficial to other animal species, contributing to biodiversity (Waithaka 2001). For example, they play a critical role within an ecosystem by using their tusks to create and expand watering holes, and clear paths through difficult terrain for other wildlife. They disperse seeds and stem bush invasion, which not only creates a more productive mix of grazing and browsing animals, it benefits subsistence herders and commercial ranchers (Halley et al. 2003, Taolo, 2003). Gallinaceous birds or gamefowl also prefer and benefit from areas with high elephant impact (Motsumi, 2002).

The activities of large herbivores, such as elephants are vital in creating plant species richness and maintaining ecosystem services in the African savanna, particularly in riparian corridors (Jacobs and Naiman 2008). The closure of the migration corridors and inability to migrate cuts the elephants off from seasonally important resources, and the opportunity for genetic exchange between populations. Furthermore, it doesn't allow time for foraged areas to regenerate, causing ecological damage both inside and outside the protected areas (Western 1989). Numerous studies highlight the need for careful evaluation of the ecological role elephants fulfill in the ecosystem before decisions to manipulate their population and distribution are made. Additionally, given the ecological and economic importance of this species is justification to encourage their range expansion beyond protected areas.

Currently, there is no one single solution to stop the crop-raiding conflicts because elephants habituate to traditional farm-based deterrents such as watchtowers, bonfires, smoke, firecrackers, bright lights, loud noises, and guarding (Bell 1984, Tchamba 1996). Novel methodologies have also been used i.e. chilirope fences. However, to remain effective, chili-ropes require a weekly application of chili-grease, making it quite labor intensive (Graham and Ochieng 2008). In most of the pilot studies, participating farmers eventually abandoned the deterrent for this reason. Labor constraints are strong determinants of whether a farm-based deterrent is adopted and maintained by the rural population.

Beehive fences have also been used, but 1) many hives become unoccupied, 2) bee activity is almost nonexistent at night when most raids occur, 3) bees are dormant in rain, high winds, and when temperatures fall close to freezing (Bromenshenk 2004). Studies have shown where these fences have been used, that bull elephants were responsible for nearly all of the recorded damage to crop fields, and beehives whether colonized or not, failed to provide much protection to the crops (Karidozo and Osborn 2007).

Electric fences are being used with more frequency (Thouless and Sakwa 1995), to stop the general elephant population from raiding crops. In many countries like Kenya, it is the preferred method to manage conflicts, where resources allow for it. One of the largest fencing projects is a 163 km district-wide electric fence in West Laikipia that creates a hard border between ranches and conservancies that serve as elephant refuges, and smallholder crop fields (Jenkins and Hamilton 1982). While many ranches and conservancies have adopted this approach, electric fences are expensive and not affordable by the local farmers, so their crop fields remain unfenced and porous to elephant movement outside of protected areas, leaving them highly vulnerable to crop raids.

Furthermore, fifteen years of intensive research concludes that it is nearly impossible to confine elephants to a designated or protected area with fences (Hoare 2012). For example, the 163 km Laikipia West electric fence, in some areas ‘funneled’ the elephants along the fence line, and released them into crop fields at the open ends of the fencing, creating massive damage, and worsening community relations in conflict areas (Smith and Kasiki 1999). The fences are also prone to failure due to lack of maintenance, and, or vandalism (Hoare 2013), and because they are constantly challenged by persistent crop-raiding elephants, also known as Habitual Raiders (HRs) that belong to a subpopulation of mature bulls (Chiyo and Cochrane 2005, Kioko et al. 2006), that have learned to break through electric fences without getting shocked to raid crops as an optimal foraging and reproductive strategy (Kioko et al. 2008).

To date, the only solution in dealing permanently with HRs is to kill them (Thouless and Sakwa 1994). However, lethal control has been proven ineffective, because crop-raiding behavior is transmitted socially within male networks, and there is an endless supply of occasionally raiding bulls that will take their place (Chiyo et al. 2011). And because of the delayed response time by management officials to conflicts, the offending elephant is rarely identified and any elephant in the immediate area is killed to appease the affected community. The constant removal of older individuals can have serious consequences for the survival of the entire herd. Male elephants like the matriarchs are repositories of ecological knowledge, and the removal of a few key individuals of either sex can have devastating results for the rest of the population (Evans and Harris 2008).

Furthermore, research on social organizations of elephants show that large aggregations are formed in response to exploitation (McKnight 2000). These aggregations are groupings of unrelated elephants that cluster in response to stress, harassment and the lack of matriarchs, and dominant bulls to lead family units as a result of previous retaliatory killings, lethal management and, or intense poaching (Lewis 1986, Ruggiero 1990), and have been shown to create more damage to crops and local vegetation, creating an endless cycle of damage and killing.

For example, in Amboseli, Kenya alone, HECs account for 65% of adult elephant deaths (Moss 2001). This mortality rate is accelerating the extinction of elephant populations that are already experiencing unprecedented declines from ivory poaching and continued human encroachment into their habitat (Haigh et al. 1979, Andren et al. 2006, Blanc et al. 2007). This makes it imperative to design new tools that will allow the elephants free movement to ancestral feeding grounds outside of protected areas without risk of crop-raiding, and to eliminate HECs at a local level, where it will build tolerance for the species, and have the most impact on its recovery.

### SUMMARY

It is clear that currently there are no barriers that can be used for general crop protection on a large-scale that are both cost-effective and practical, that will effectively deter the Habitual Raiders (HRs) from raiding crops, and still allow for their free movement along migration corridors that are bordered by small-holder and commercial crop fields.

While barriers such as fences are an important component in controlling general crop-raiding behavior, what researchers and practitioners have neglected to consider thus far in their management schemes is that many years of elephant fence design shows that the smaller fences that encircle individual crop fields are better maintained, thus more effective against elephant incursions. This is primarily on account of highly motivated, management practices through pride of ownership by individual farmers. However, as stated earlier, those with resources can only afford fences and the smallholder crop fields remain unfenced making them vulnerable to crop-raids.

Furthermore, the intelligence, memory and problem-solving abilities of the elephant have not been taken into account, and no one has thus far, considered permanently changing the fence-breaking behavior of the HRs.

The invention described uses pre-existing or newly built electric or nonelectric fences, depending on elephant pressure, to keep elephants in protected areas, or to encircle individual crop fields or other important resources i.e. water installations and granaries needing protection. The fences are fitted with bells every 10 ft-20 ft. The HRs are conditioned using punishment in the form of bear-scare darts or rubber bullets applied to their rump, causing pain but not injury, when they sound the bells in an attempt to break through the fences. Punishment is delivered immediately after the fence is disturbed and the bells jingle, not before. After one or two trials, the bells will become an alarm/signal or cue to the HR that the aversive stimulus/pain is coming. It will trigger an avoidance behavior in the HR. The HR will respond to the jingle of bells by immediately running from the fence, before the aversive stimulus/pain occurs. At which point, the HRs will be deterred by the sound of the bells alone, without ever having to use the bear-scare darts or rubber bullets again.

Elephant VEXING is a form of stimulus control, because it puts behavior under control of a stimulus, in this case, the warning jingle of bells. This kind of learning occurs quickly in animals, and is extremely durable.

### DETAILED DESCRIPTION

The ecological and conservation advantages of aversive conditioning lie in the fact that HRs are not removed from their male networks and established territories. If HRs can be conditioned to avoid breaking fences, their continued presence would be beneficial in maintaining a stable, heterogeneous age structure. Furthermore, the conditioned HRs would set an example for their younger associates that learn from direct observation, to avoid fences that enclose crop fields, which will eliminate the development of future persistent raiders as they reach their reproductive prime.

The behavior modification methodology outlined in this document is designed to be all-inclusive: it stops both general crop-raiding, and specifically crop-raiding by Habitual Raiders. For behavior modification to work, there must be fencing around crop fields and other valuable resources needing protection.

With the proven design of smaller, individually-owned fences, 1) electric fences will be installed around affected crop fields, so that it will discourage the general population from raiding crops, 2) and the alarm/signal the HRs will be aversively conditioned to, will be added to the individual fences, so that the fences are rendered 100% effective in stopping all fence-breaking and crop-raiding activities. And since connectivity to important seasonal resources is critical for elephants, the individual fence design with the alarm/signal will allow for range expansion/free movement of elephants through areas outside of sanctuaries without the risk of crop loss and associated killings.

Using Stimulus Control to Stop Fence-Breaking Behavior in Habitual Crop Raiding Elephants (HRs)

Elephant VEXING is a technique based on operant conditioning, which is one of the fundamental concepts in behavioral psychology. It's a process by which humans and animals learn to behave in such a way as to obtain rewards and avoid punishments. This methodology was designed to permanently stop the persistent fence-breaking behavior of ‘problem’, crop-raiding elephants known as ‘Habitual Raiders,’ (HRs). This technique is to be used in areas with persistent crop-raiding damage, along corridors bordered by crop fields, in order to reduce and eventually eliminate the incidence of fence-breaking/crop-raiding by elephants in general and Habitual Raiders specifically.

Personnel:

A team trained in Elephant VEXING, who are professional wildlife managers.

Equipment:
Economical fencing material where needed.
Bells (functions as a cue/signal, and must be a discriminative stimulus).
Paintball gun
Invisible fluorescing powder
Infrared scope and glasses
Shotgun and/or dart gun
Rubber bullets, Bear-Scare Darts
GPS collars

Elephant Vexing:

Identify the crop fields, migration corridors that border crop fields, and general areas that have heightened and persistent crop-raiding activity.

If there are preexisting fences that have been damaged by elephants, it must be repaired. In areas that do not have any fencing, use economical fencing to partition off the crops and valuable resources.

Hang bells along the fencing (other stimuli can be added as well). On electric fencing, hang bells on the posts so that when the HR disturbs the post, the bells will jingle. This must be done prior to the conditioned HRs moving through the area.

Identify the Habitual Raiders and GPS collar the ones that will be tracked—HRs are randomly distributed among male networks. They will be older male elephants. There may also be other younger associates within the male network that crop-raid alongside the HR in the group. The Habitual Raider is the male elephant that initiates the raid, either by breaking fences to get at crops or is the first to enter an open crop-field, before others follow his lead.

Mark the HR on either side of the rump with the fluorescing dye when collaring. The dye is a ‘sauce’ made from invisible fluorescing powder i.e. fluorescent-dyed nanoparticles that are undetectable under normal lighting, but can be seen through an infrared scope or glasses. This will mark the target area on the HR where the aversive stimuli will be applied, and will be readily seen at night when most crop raiding takes place.

Follow and observe the movements of the HR. Stay a discreet distance away as not to be obvious, but close enough to shoot the HR in the rump with a rubber bullet or Bear-Scare dart if it initiates fence-breaking. The shotgun must be calibrated to deliver enough force to cause pain, but not injury.

When to apply the aversive stimulus. When the HR initiates fence breaking to access the crops on the other side, the bells will jingle as fencing is broken or the posts are pushed over.

The bells are a cue for the shooter to deliver the rubber bullet/Bear-Scare dart (aversive stimulus) to the rump of the HR. The aversive stimulus must happen immediately AFTER the bells start jingling, NOT BEFORE.

Animals respond in predictable ways to avoid pain; aversive stimulus. The response to the aversive stimulus will be a ‘get me out of here,’ reaction. The HR will run from the fence in order to escape the pain.

Because the jingling of the bells occurs right before the aversive stimulus/pain is delivered, the jingling bells become an alarm/signal or cue to the HR that the aversive stimulus/pain is coming.

After one or two occurrences/trials of the aversive stimulus/pain, the alarm/signal (jingling bells) will trigger an avoidance behavior in the HR. The HR will respond to the jingle of bells by immediately running from the fence, before the aversive stimulus/pain occurs.

Elephant VEXING is a form of stimulus control, because it puts behavior under control of a stimulus, in this case, the warning jingle of bells. This kind of learning occurs quickly in animals, and is extremely durable (Solomon et al. 1953, Sidman 1955, Murphy and Miller 1956, Seligman 1971).

Avoidance Behaviors Are Persistent

Countless trials have been undertaken using rodents, dogs and primates, proving avoidance behaviors are incredibly persistent. This holds true even when there is no longer anything to avoid (Solomon et al. 1953, Sidman 1955, Murphy and Miller 1956, Seligman 1971). The reason is that an animal that performs an avoidance reaction never experiences the aversive stimulus/pain. But it receives negative reinforcement (avoidance of potential pain) in the form of relief. Because of this, avoidance behavior is self-reinforcing. It keeps going forever, because relief functions as a reinforcer even if the original threat is removed.

For example: The HR will respond to jingling bells by running from the fence hundreds of times, even if the rubber bullet or Bear-Scare dart is never used again. Because each time the HR runs from a fence, it most likely figures that it has avoided pain. In fact, the HR escapes an aversive internal state, caused by the conditioned stimulus, which is the jingle of bells.
Fencing on which bells can be hung must exist around crop fields and valuable areas for behavior modification through Elephant VEXING to work.
Bells function as a cue/signal, and must be a discriminative stimulus; the same brand must be universally used. Although there could be stimulus generalization, where the HR responds to a similar sounding bell in a different area, to ensure the signal/cue is not subject to failure, the same make of bells should be used in all areas where the HR(s) move through on migrations . . . etc.
The ‘sauce’ to mark the HRs are made from IR—Infrared to visible fluorescing powder (commercially available). When stimulated with infrared light, the powder will fluoresce in the visible range.

Fortunately, HRs are randomly distributed between male networks, and these networks are close-knit, so while males within a particular group are likely to learn from each other, the transmission of any crop-raiding behavior to other networks won't happen.

So when Elephant VEXING is used on identified HRs, it will most likely minimize the spread of raiding behavior through social learning within their network. If there are younger raiders, and they are targeted, it may deter them from raiding in later years when they reach their reproductive peak.

Maintenance of the individually owned fencing to make certain bells are intact can be done by the farmers themselves. Bells on fencing along migration corridors can be maintained by owners of the protected areas or governmental wildlife personnel. Most importantly, it must be determined that the HRs are not breaking fences to raid crops on account there is inadequate forage and they are starving. When planning out the particulars of this methodology, the area must be surveyed to make certain there is sufficient forage to maintain the HRs and the rest of the population. While this methodology will allow elephants to roam freely through areas bordered by farms without the risk of crop-raids, there must be buy-in from the rural population.

Since most of the elephant's range remains unfenced, it would be a sound conservation scheme and investment to provide the affected villagers with a simple electric fence design to enclose their crop fields, on which the alarm/signal will be added. This would not only protect their crops from the elephants, it would work to build tolerance for the species once the elephants no longer present a threat to their livelihoods.

The fences can be offered in exchange for surveillance and reporting of any suspicious activity directed at the elephants.

I claim:

1. A method of discouraging elephants from raiding crops, comprising:
providing a fence around a crop field to be protected;
providing an alarm connected to the fence that will be triggered in response to the presence of an elephant;
monitoring the fence and or the alarm for the presence of an elephant; and
aversively conditioning elephants who are present from breaking through the fence.
